(19) United States
(12) Patent Application Publication
(10) Pub. No.: US 2025/0013049 A1
(43) Pub. Date: Jan. 9, 2025

(54) INFORMATION PROCESSING DEVICE, HEAD-MOUNTED DISPLAY DEVICE, ELECTRONIC DEVICE, AND INFORMATION PROCESSING METHOD

(71) Applicant: CANON KABUSHIKI KAISHA, Tokyo (JP)

(72) Inventor: WENJING LI, Tokyo (JP)

(21) Appl. No.: 18/756,608

(22) Filed: Jun. 27, 2024

(30) Foreign Application Priority Data
Jul. 4, 2023 (JP) 2023-109839

(51) Int. Cl. G02B 27/01; H04N 13/111

(52) U.S. Cl. CPC G02B 27/0172; H04N 13/111

(57) ABSTRACT

An information processing device includes one or more processors and/or circuitry configured to: perform first acquisition processing to acquire information on a setting item of an electronic device, perform second acquisition processing to acquire information on an operation screen region of the electronic device in a three-dimensional space that represents a view seen by a user; perform display control processing to display an object representing the setting item of the electronic device outside the operation screen region in the three-dimensional space, and to change the object being displayed in accordance with the operation screen region in the three-dimensional space; and perform transmission processing to transmit information on a setting item corresponding to the object that was moved to the electronic device in response to an operation by the user moving the object into the operation screen region.

### BACKGROUND OF THE INVENTION

### Field of the Invention

The present invention relates to an information processing device, a head-mounted display device, an electronic device, an information processing method, and a computer-readable memory medium.

### Description of the Related Art

With the sophistication of electronic devices (such as smartphones and mirrorless cameras) in recent years, the number of configurable setting items has increased and the configuration operation of graphical user interfaces (GUIs) of electronic devices has become more complex. Users wishing to change the displayed items according to the purposes or preferences can customize the screen by operating the electronic device itself or through a personal computer (PC) connected to the electronic device.

Meanwhile, the recent years have seen the spread of mixed reality (MR) technologies. A head-mounted display (HMD), for example, uses an MR technique to present a computer-generated virtual image over a camera-captured real image to the user wearing the HMD. Thus HMDs can provide a larger amount of information than a real space image.

For example, Japanese Patent Application Publication No. 2018-180776 describes a method whereby virtual item buttons related to a selected job are displayed in a transmissive display unit of an HMD so that these virtual item buttons can be operated.

However, when the user wishes to change the settings of an item other than a selected specific job, it is sometimes challenging to locate the desired item in a complex hierarchical structure.

### SUMMARY OF THE INVENTION

The present invention provides a technique that enables users to readily locate desired setting items of an electronic device and to change the settings of the electronic device with simple operations.

An information processing device according to the present invention includes one or more processors and/or circuitry configured to: perform first acquisition processing to acquire information on a setting item of an electronic device, perform second acquisition processing to acquire information on an operation screen region of the electronic device in a three-dimensional space that represents a view seen by a user; perform display control processing to display an object representing the setting item of the electronic device outside the operation screen region in the three-dimensional space, and to change the object being displayed in accordance with the operation screen region in the three-dimensional space; and perform transmission processing to transmit information on a setting item corresponding to the object that was moved to the electronic device in response to an operation by the user moving the object into the operation screen region.

Further features of the present invention will become apparent from the following description of exemplary embodiments with reference to the attached drawings.

### BRIEF DESCRIPTION OF THE DRAWINGS

FIG. 1A is a diagram illustrating a hardware configuration example of an HMD;

FIG. 1B is a diagram illustrating a hardware configuration example of a camera;

FIG. 2 is a block diagram illustrating a functional configuration example of the HMD and camera;

FIG. 3 is a diagram illustrating an example of a virtual space generated by the HMD;

FIG. 4 is a diagram illustrating an example of setting item information;

FIG. 5 is a flowchart illustrating an example of processing in the HMD according to Embodiment 1;

FIG. 6 is a diagram illustrating an example of a user operation in a virtual space;

FIG. 7 is a diagram illustrating another example of a user operation in the virtual space;

FIG. 8 is a flowchart illustrating an example of processing for determining a display position of a setting item;

FIG. 9 is a diagram illustrating a display example of setting items in a virtual space;

FIG. 10 is a diagram illustrating another display example of setting items in the virtual space;

FIG. 11 is a flowchart illustrating an example of a setting process of the camera; and

FIG. 12 is a flowchart illustrating an example of processing in the HMD according to Embodiment 2.

### DESCRIPTION OF THE EMBODIMENTS

Embodiments according to the present invention will be hereinafter described with reference to the drawings. The present invention is not limited to the following embodiments. The configurations of the embodiments can be modified or altered as suited depending on the specification of the apparatus to which the present invention is applied, or on various conditions (such as conditions and environment of use). The present invention can be implemented by combining parts of various embodiments. The same elements are given the same reference numerals in the description of the embodiments.

### Embodiment 1

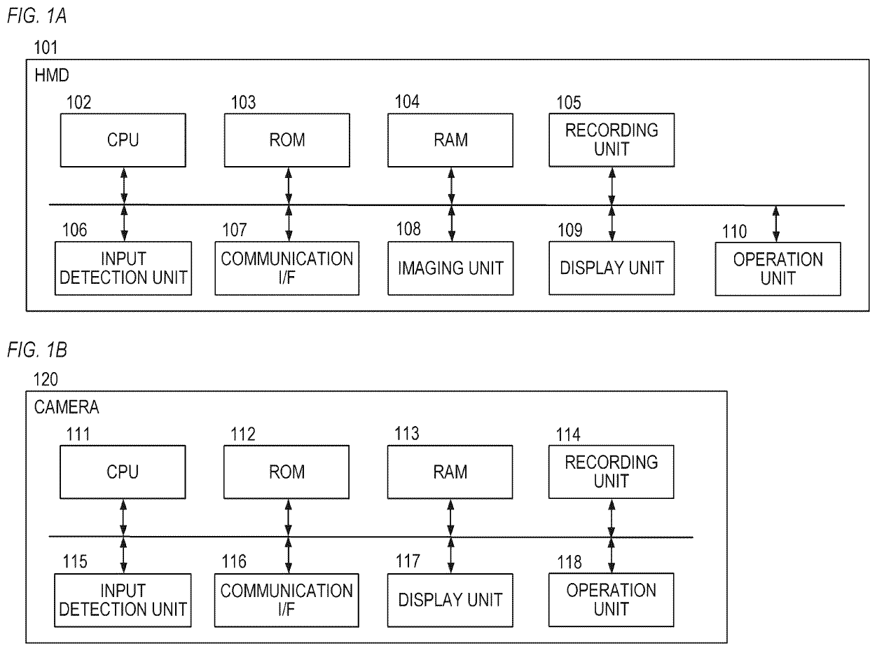

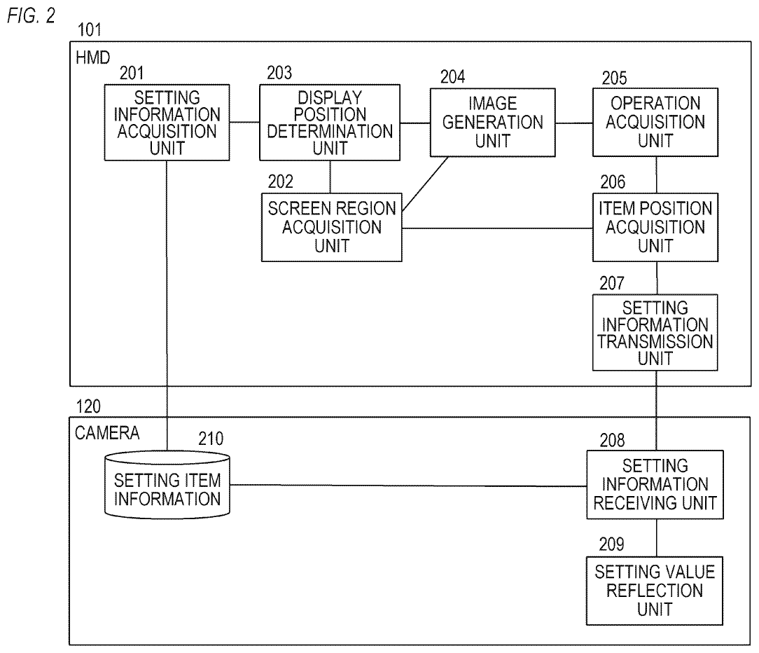

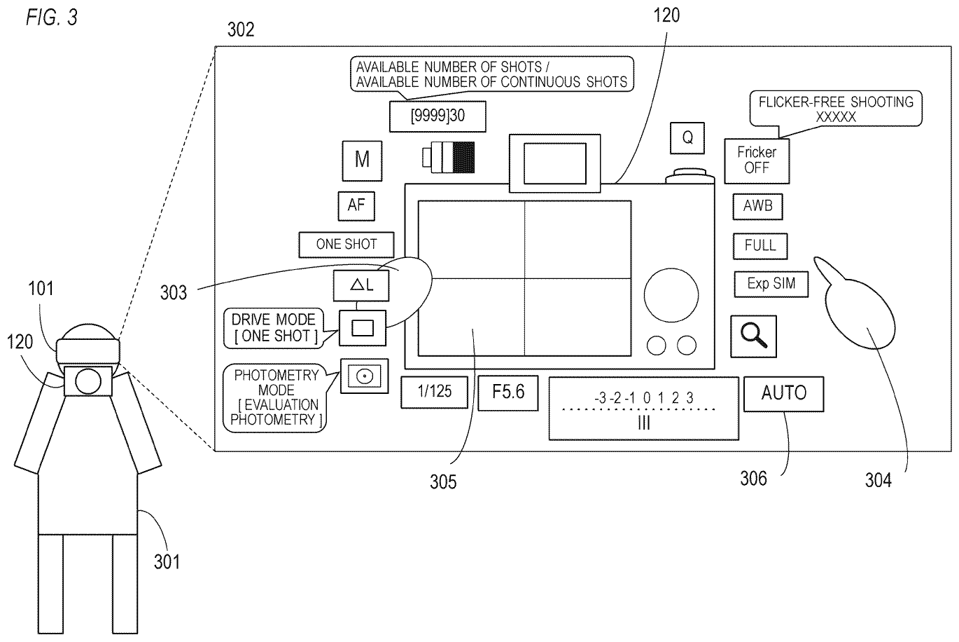

FIG. 1A is a diagram illustrating a hardware configuration example of an HMD 101 as an information processing device. FIG. 1B is a diagram illustrating a hardware configuration example of a camera 120 as an electronic device. FIG. 2 is a block diagram illustrating a functional configuration example of the HMD 101 and camera 120. FIG. 3 is a diagram illustrating an example of a virtual space generated by the HMD 101. While the information processing device is an HMD 101 (or included in an HMD 101) in the example described below, the information processing device may be configured as another apparatus connected to the HMD 101.

The following describes, with reference to FIG. 3, one example of displaying objects (virtual objects) representing setting items of the camera 120 in a virtual space, to allow a user to easily locate a desired item and to change the settings. FIG. 3 shows an example of a virtual space generated by the HMD 101. The user is able to change the settings of the real camera 120 through the HMD 101 worn by the user.

FIG. 3 shows a virtual space 302 displayed in a display unit 109 of the HMD 101 worn by the user 301. The display unit 109 shows the camera 120, the left hand 303 of the user 301, and the right hand 304 of the user 301. The camera 120 has an operation screen 305. FIG. 3 shows an example in which the user 301 holds the camera 120 with the left hand 303, and manipulates objects placed in the virtual space 302 with the right hand 304.

The objects placed in the virtual space 302 are virtual objects generated by computer graphics (CG) techniques, and represent setting items 306 that are displayable in the operation screen 305 of the camera 120. The display positions of the objects are determined such that the objects do not overlap a certain region such as the operation screen 305, for example.

The HMD 101 is not limited to a helmet-mounted type and may be an eyewear type, for example. The HMD 101 may either be a video see-through HMD or an optical see-through HMD. Hereinafter, the HMD 101 will be described as a video see-through, head-mounted display device. In the case where the HMD 101 is an optical see-through HMD, the real space seen by the user is not an image captured by an imaging unit 108, but the actual view seen through the lenses of the HMD 101.

The HMD 101 determines the display positions of the objects corresponding to respective setting items based on the size and position of the operation screen 305 displayed in the display unit 109, for example. The user 301 can move the objects and change the positions of the objects by a predetermined operation. When an object is moved by a predetermined operation by the user 301, the HMD 101 transmits the information on the setting item corresponding to the moved object to the camera 120.

The setting item information may include setting values, and in addition, the information on the position in the operation screen 305 after the move. The user can move an object representing a setting item to a desired position in the operation screen 305. Based on the information received from the HMD 101, the camera 120 displays the setting item at the position specified by the user in the real operation screen 305, too. Thus the user can readily customize the screen of the camera 120.

The predetermined operation may be any action that can cause an object representing a setting item to be moved, such as drag and drop, for example, or taps on the positions of the object before and after the move. The predetermined operation may include a voice operation, too.

The HMD 101 displays, in its display unit 109, not only the objects representing the setting items associated with the screen configuration currently shown in a display unit 117 of the camera 120, but also the objects representing setting items not associated with the current display. The user 301 can readily locate settings of the camera 120 without having to search for a desired setting item in a complex hierarchical structure, which allows the user to change the settings with simple operations. The electronic device whose settings are to be changed is not limited to the camera 120, but also includes various devices that have an operation screen, such as smartphones and printers.

The hardware configurations of the HMD 101 and camera 120 will be described with reference to FIGS. 1A and 1B. FIG. 1A is a diagram illustrating a hardware configuration example of the HMD 101. The HMD 101 generates an image of an MR space, and displays it in the display unit 109. The image is obtained by displaying CG-generated virtual objects over an image of a real space that was captured by an imaging device (imaging unit 108) mounted in the HMD 101. The HMD 101 may also display an image of a VR space, which is generated by placing virtual objects in a CG-generated virtual space, in the display unit 109. MR and VR are known technologies, and therefore will not be described in detail.

CPU 102, which is a system controller, controls the overall operation of the HMD 101. The CPU 102 executes programs to implement various types of processing performed by the HMD 101. ROM 103 is a read-only memory that stores programs and parameters that remain unchanged, such as basic programs and initial data. RAM 104 is a memory that temporarily stores operation results and input information during information processing or image processing.

Recording unit 105 is a device that is able to write and read various types of information, and includes a hard disk and a memory card, whether built-in or external, of the HMD 101. The recording unit 105 may also include a memory card, a flexible disc, an IC card and the like, that can be mounted to and removed from the HMD 101.

The recording unit 105 records various programs that implement the processing in the HMD 101. The CPU 102 can implement the processing in the HMD 101 by reading out a program from the recording unit 105 and deploying and executing the program in the RAM 104. The program executed by the CPU 102 may be stored in the ROM 103.

The recording unit 105 can record information about user operations input via an input detection unit 106, and information about the position and orientation of the user detected by an acceleration sensor or the like equipped in the HMD 101. The recording unit 105 records the setting item information of the camera 120.

The input detection unit 106 receives inputs from the user via an operation unit 110. The input via the operation unit 110 includes an input by a hand movement recognized by hand tracking, for example.

Reference numeral 107 denotes a communication interface (I/F) capable of sending and receiving data to and from an operation device for operating the HMD 101 or a cloud. In the case where the information processing device according to the present invention is configured separately from the HMD, the communication I/F 107 receives audio data acquired by a microphone in the HMD, position and orientation information detected by the HMD, and images captured by the HMD, via a network. Connections for input and output via the communication I/F 107 include a local connection through USB or Bluetooth®, and Internet connections via Ethernet or Wi-Fi.

The imaging unit 108 is an imaging device mounted in the HMD 101. Live-action videos captured by the imaging unit 108 are used for the tracking of hand or joint movements of the user by image recognition processing, or for the detection of a flat surface for overlaying virtual objects such as buttons or icons. Images taken by the imaging unit 108 are also used to recognize the operation screen of the camera 120.

The display unit 109 is an electronic display device such as a liquid crystal display device. The display unit 109 receives user instructions that are recognized by hand tracking. The display unit 109 displays images such as a VR world based on the instructions from the user and on the information stored in the recording unit 105.

The operation unit 110 includes an operation device that enables pointing operations and inputting of various commands and the like by hand movements, i.e., obtains operation instructions and commands from the user. Specifically, the operation unit 110 acquires the information input by a hand movement of the user manipulating an object representing a setting item in the virtual space. The information on the operations performed on the objects by the user is sent to the input detection unit 106. The function of the operation unit 110 is not limited to acquiring the information input by hand movements that are recognized by hand tracking. The operation unit may have the function of acquiring information input via a controller including a mouse or keyboard, and voice input information.

FIG. 1A illustrates a configuration example in which the information processing device according to the present invention is integral with the HMD 101, and therefore the HMD 101 includes the operation unit 110 and display unit 109 as internal configurations. When the information processing device according to the present invention is constructed with a PC or the like that is separate from the HMD 101, the information processing device need not include the operation unit 110 and display unit 109. In this case, the information processing device acquires the information on user operations from the HMD as an external device, and transmits data of generated virtual space to the HMD.

FIG. 1B is a diagram illustrating a hardware configuration example of the camera 120. CPU 111, which is a system controller, controls the overall operation of the camera 120. The CPU 111 executes programs to implement various types of processing performed by the camera 120. ROM 112 is a read-only memory that stores programs and parameters that remain unchanged, such as basic programs and initial data. RAM 113 is a memory that temporarily stores operation results and input information during information processing or image processing.

Recording unit 114 is a device that is able to write and read various types of information, and includes a hard disk and a memory card, whether built-in or external, of the camera 120. The recording unit 114 may also include a memory card, a flexible disc, an IC card and the like, that can be mounted to and removed from the camera 120.

The recording unit 114 records various programs that implement the processing in the camera 120. The CPU 111 can implement the processing in the camera 120 by reading out a program from the recording unit 114 and deploying and executing the program in the RAM 113. The program executed by the CPU 111 may be stored in the ROM 112. The recording unit 114 records data used in the programs that are executed by the CPU 111.

The input detection unit 115 receives input from the user via an operation unit 118. The input via the operation unit 118 includes input through manipulation of a touchscreen or button, for example.

A communication I/F 116 is a communication interface capable of sending and receiving data to and from the HMD 101 and a cloud or the like. Connections for input and output via the communication I/F 116 include a local connection through USB or Bluetooth, and Internet connections via Ethernet or Wi-Fi. The HMD 101 and camera 120 communicate with each other via the communication I/F 107 and communication I/F 116.

The display unit 117 is an electronic display device such as a liquid crystal display device. The display unit 117 receives user instructions given by touch actions on a display. The display unit 117 displays the GUI of the operation screen based on the instructions from the user and on the information stored in the recording unit 114.

The operation unit 118 obtains operation instructions given by the user to the camera 120 such as by operations of a button or touchscreen. The operation unit 118 obtains the information input by the user operating the camera 120 to change the settings of some setting items. The information on the user operations on the camera 120 is sent to the input detection unit 115 and HMD 101.

FIG. 2 is a block diagram illustrating a functional configuration example of the HMD 101 and camera 120. The HMD 101 includes a setting information acquisition unit 201, a screen region acquisition unit 202, a display position determination unit 203, an image generation unit 204, an operation acquisition unit 205, an item position acquisition unit 206, and a setting information transmission unit 207. The camera 120 includes a setting information receiving unit 208 and a setting value reflection unit 209. The camera 120 retains setting item information 210 in the recording unit 114.

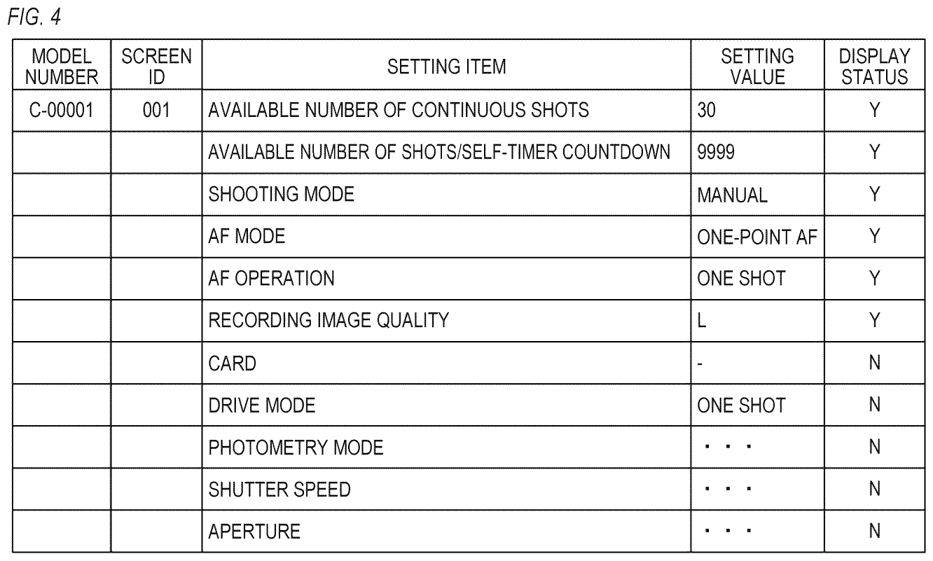

The setting information acquisition unit 201 acquires setting item information 210 retained in the camera 120 that is the target of operation. FIG. 4 shows an example of setting item information 210. The setting item information 210 includes the model number, screen ID, setting items, setting values, and display status of the camera 120. The display status refers to a flag indicating whether or not an item is displayed in the operation screen of the camera 120 (Y: displayed, N: not displayed).

The setting information acquisition unit 201 may acquire, not only the setting item information 210 retained in the camera 120, but also the setting item information of the camera 120 preliminarily stored in the recording unit 105. The recording unit 105 can retain the setting item information for each model number of various cameras 120. The setting information acquisition unit 201 can obtain model number information from a camera 120, and then acquire the setting item information corresponding to this camera 120 from the recording unit 105.

The screen region acquisition unit 202 acquires information on the operation screen region of the camera 120 operated by the user. Specifically, the screen region acquisition unit 202 acquires the information indicating the position and size of the operation screen region of the camera 120, using image recognition or other known techniques. The position of the operation screen region can be obtained not only by image recognition but also other known techniques such as SLAM (Simultaneous Localization and Mapping).

The display position determination unit 203 performs display control to change the objects representing setting items being displayed in accordance with the operation screen region in the virtual space. Namely, the display position determination unit 203 determines which of the objects representing setting items is to be displayed in the virtual space.

The display position determination unit 203 determines the display position of the object for each setting item. The display position determination unit 203 determines the display positions of the objects representing setting items, for example, based on the position and size of the operation screen region of the camera 120, which is being displayed in the display unit 109 of the HMD 101 worn by the user.

The objects representing setting items that are displayed in the display unit 109 are icons indicating the setting items, for example. The objects representing setting items may each be associated with the information on a setting value of each setting item. Alternatively, the objects representing setting items may include objects that indicate a description of setting items.

The image generation unit 204 generates an image of a virtual space in which objects representing setting items are overlaid at three-dimensional positions determined by the display position determination unit 203 on a real space image that was captured by the imaging unit 108 of the HMD 101.

The operation acquisition unit 205 obtains user operations performed on the objects representing the setting items that are placed in the virtual space. The image generation unit 204 generates an image after objects representing setting items have been moved to other display positions, based on the user operations obtained by the operation acquisition unit 205. The user can move an object representing a setting item to a desired position in the operation screen.

The item position acquisition unit 206 obtains the display position of an object representing a setting item after it was moved. The setting information transmission unit 207 determines whether or not the display position of the object representing a setting item after it was moved is contained in the operation screen region of the camera 120. When the display position of the object is contained in the operation screen region of the camera 120, the item position acquisition unit 206 transmits the information on the setting item corresponding to this object to the camera 120.

The setting information receiving unit 208 of the camera 120 receives the information on the setting item corresponding to the object moved into the operation screen region from the setting information transmission unit 207 of the HMD 101. The received information on setting items (such as setting values and display statuses) is stored as the setting item information 210.

The setting value reflection unit 209 reflects the information on the setting item received from the setting information receiving unit 208 in the settings of the camera 120. The setting value reflection unit 209 changes the settings of the camera 120 based on the setting values included in the setting item information. The setting value reflection unit 209 also displays the setting item in the real operation screen of the camera 120 at the position to which the object was moved by the user operation.

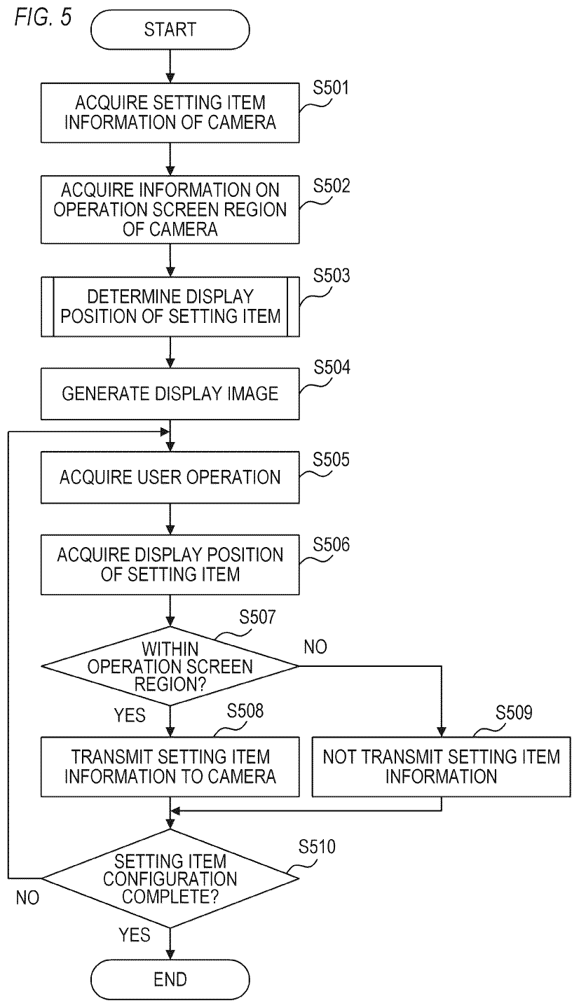

FIG. 5 is a flowchart illustrating an example of processing in the HMD 101 according to Embodiment 1. The processing shown in FIG. 5 is implemented by the CPU 102 executing a program corresponding to each step of the processing. The processing of FIG. 5 may be executed at any timing. The processing of FIG. 5 may be executed at designated time intervals, for example, or when a user operation is detected.

At step S501, the setting information acquisition unit 201 of the HMD 101 acquires the information on setting items that can be displayed in the operation screen 305 of the camera 120 from the setting item information 210. The setting information acquisition unit 201 records the acquired setting item information in the recording unit 105. By recording the setting item information acquired from the camera 120 in the recording unit 105 once, the setting information acquisition unit 201 can obtain this setting item information stored in the recording unit 105 from the next session of processing onward. In the case where the setting item information for each model number of various cameras 120 is already stored in the recording unit 105, the setting information acquisition unit 201 can obtain the information of the model number from the camera 120, and then acquire the corresponding setting item information from the recording unit 105. The camera 120 need only transmit its model number information instead of the setting item information to the HMD 101.

At step S502, the screen region acquisition unit 202 acquires information on the operation screen region of the camera 120 in a virtual space (three-dimensional space) that will be the view seen by the user. Specifically, the screen region acquisition unit 202 acquires the information indicating the position and size of the operation screen region. The screen region acquisition unit 202 can acquire the information on the operation screen region by detecting the operation screen of the camera 120 from an image captured by the imaging unit 108, for example.

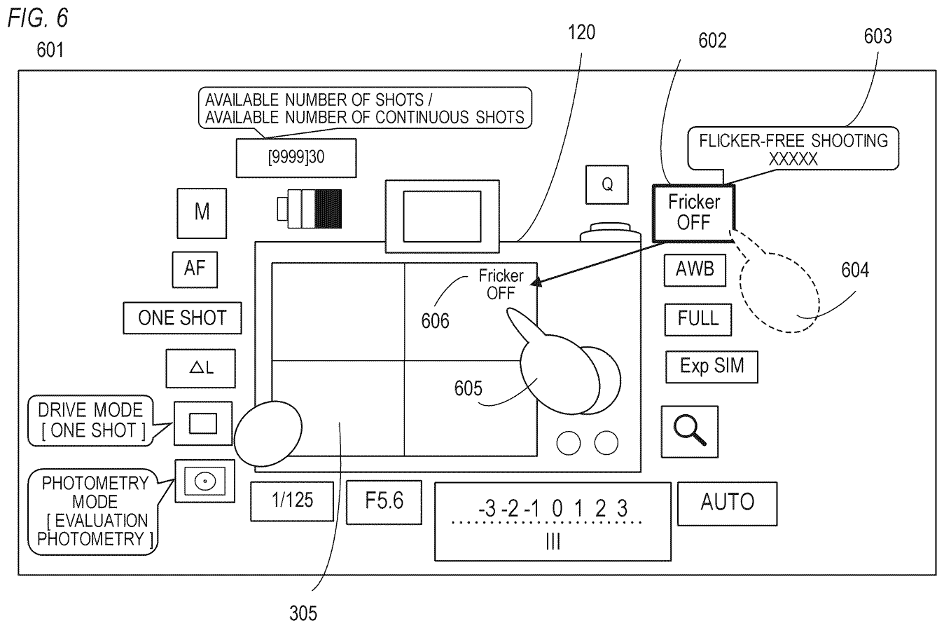

At step S503, the display position determination unit 203 determines display positions of objects representing setting items based on the setting item information acquired at step S501 and the information on the operation screen region of the camera 120 acquired at step S502. The display position determination unit 203 determines the display positions of the objects such that the objects representing setting items will be placed outside the operation screen region, for example. Here, the display position determination unit 203 may determine the display positions such that the objects corresponding to the items currently being displayed in the operation screen of the camera 120 are displayed as an overlay within the region of the operation screen 305. The display position determination process performed by the display position determination unit 203 will be described in more detail later with reference to the flowchart of FIG. 6.

At step S504, the image generation unit 204 generates an image in which objects representing setting items are overlaid at the display positions determined at step S503 on a real space image that was captured by the imaging unit 108.

The image generation unit 204 may obtain an image captured by the imaging unit 108, or may obtain, from the camera 120 via the communication I/F 116 and communication I/F 107, an image being displayed in the display unit 117 of the camera 120. The image of the operation screen may be obtained from the images stored in advance in the recording unit 105 of the HMD 101. In this case, the HMD 101 can obtain the screen ID information of the screen that is currently displayed in the operation screen from the camera 120, thereby to obtain the image of the corresponding operation screen from the recording unit 105. The image generation unit 204 need only combine the obtained image of the operation screen with the operation screen region in the real space image captured by the imaging unit 108.

At step S505, the operation acquisition unit 205 obtains user operations performed on the objects representing setting items in the virtual space. The user operation is, for example but not limited to, a hand movement recognized by hand tracking. The user operation may be an eye gaze or voice operation. The user operation may also involve a hand movement, an eye gaze operation, and a voice operation, combined as suited.

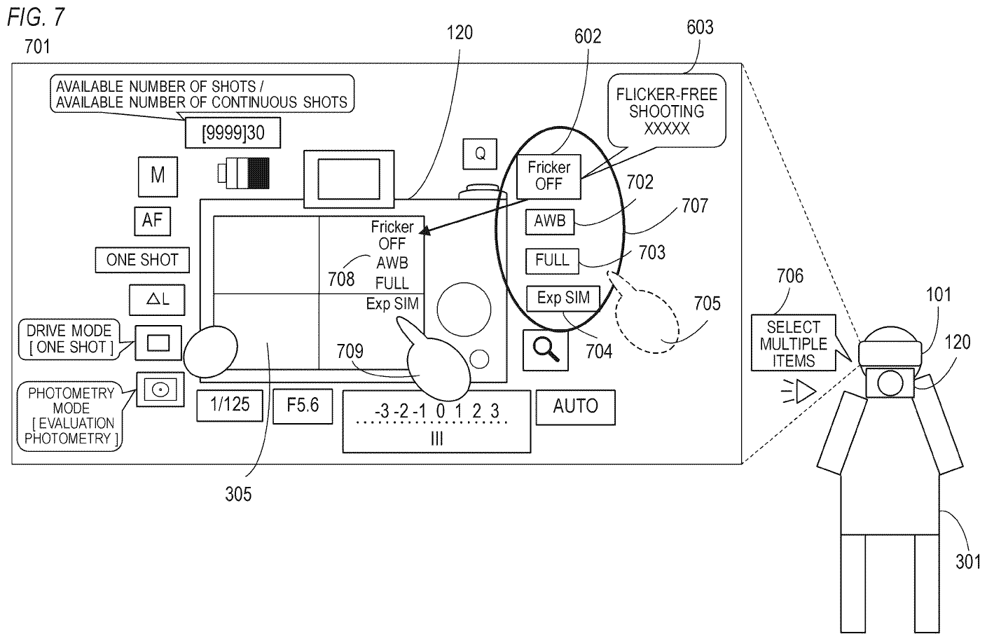

The process of obtaining user operations at step S505 will be described with reference to FIG. 6 and FIG. 7. The operation acquisition unit 205 can obtain a user operation which is, for example, a hand movement recognized by hand tracking for moving an object representing a setting item. FIG. 6 and FIG. 7 are diagrams illustrating examples of user operations in a virtual space. In the description with reference to FIG. 6 and FIG. 7, the objects representing setting items will be referred to simply as “setting items.”

FIG. 6 shows an example of a user operation that is a hand movement for moving one of the setting items. The image of the virtual space 601 shows the camera 120, a plurality of setting items, texts describing the setting items, and a user's hand. The hand 604 represents the user's hand before moving a setting item 602 (Flicker OFF). The hand 605 represents the user's hand after having moved the setting item 602 into the operation screen region. Reference numeral 603 denotes a text that describes the setting item 602. The text 603 may be displayed for a predetermined time, for example, when the user's hand comes over the setting item.

The user selects the setting item 602 displayed in the virtual space 601 with the hand 604, and moves it over to a desired position within the region of the operation screen 305 of the camera 120. The setting item 602 is placed at the position (denoted at 606) to which the user has moved the setting item.

The setting information transmission unit 207 of the HMD 101 transmits the setting item information corresponding to the setting item 602 to the camera 120 in response to the user operation that moved the setting item 602 into the region of the operation screen 305. The setting information receiving unit 208 of the camera 120 receives the information on the setting item 602 from the setting information transmission unit 207. The setting value reflection unit 209 reflects the settings of the setting item 602 in the camera 120 in real time based on the information received by the setting information receiving unit 208. Namely, the setting value reflection unit 209 displays the setting item 602 in the real operation screen 305 of the camera 120 at the position 606 to which it was moved by the user operation. The setting value reflection unit 209 applies the “Flicker OFF” setting to the camera 120.

When the setting item 606 after the move is displayed in the region of the operation screen 305, the image generation unit 204 of the HMD 101 stops displaying the setting item 602 and text 603 that were shown outside the region of the operation screen 305. Since the region of the operation screen 305 has limited space, the image generation unit 204 executes control such that descriptions of setting items are not shown within the region of the operation screen 305.

FIG. 7 shows an example of a user operation that is a combination of a voice (of the user 301) and hand gestures of encircling plural setting items and moving them. The image of the virtual space 701 shows the camera 120, a plurality of setting items, texts describing the setting items, and a hand of the user 301. The hand 705 represents the hand of the user 301 before moving setting items 602 and 702 to 704. The hand 709 represents the user's hand after having moved the setting items 602 and 702 to 704 into the region of the operation screen 305. The user 301 utters a voice 706 saying “select multiple items” and performs a gesture of encircling the setting items 602 and 702 to 704 displayed in the virtual space 701 with the hand 705. These multiple setting items can thus be selected.

In the image of the virtual space 701, the selected multiple setting items may be highlighted by a change in the displayed style such as illuminated, or a trace 707 of the movement of the hand 705 encircling the plurality of setting items may be displayed. After selecting the multiple setting items 602 and 702 to 704, the user moves them over to a desired position in the operation screen 305 of the camera 120. The setting items 602 and 702 to 704 are placed at the position 708 to which the user has moved the setting items.

When the setting items 602 and 702 to 704 are moved into the region of the operation screen 305, the setting information receiving unit 208 of the camera 120 receives the information on the setting items 602 and 702 to 704 from the setting information transmission unit 207 of the HMD 101. The setting value reflection unit 209 reflects the settings of the setting items 602 and 702 to 704 in the camera 120 in real time based on the information received by the setting information receiving unit 208. Namely, the setting value reflection unit 209 displays the setting items 602 and 702 to 704 in the real operation screen 305 of the camera 120 at the position 708 to which they were moved by the user operation. The setting value reflection unit 209 applies the respective settings of the setting items to the camera 120.

While FIG. 7 illustrates one example of an operation of moving setting items by a combination of a hand movement operation and voice, the user operation is not limited to this example. The user operation may be an eye gaze input for selecting a setting item. The user operation may be a hand gesture for selecting a setting item, or for changing the operation contents.

At step S506 of FIG. 5, the item position acquisition unit 206 obtains a display position of the object representing the setting item that was moved by the user operation at step S505.

At step S507, the item position acquisition unit 206 determines whether or not the object representing the setting item that was moved by the user operation is present within the operation screen region of the camera 120. When the object representing the setting item that was moved is present within the operation screen region of the camera 120, the process proceeds to step S508. When the object representing the setting item that was moved is not present within the operation screen region of the camera 120, the process proceeds to step S509.

At step S508, the setting information transmission unit 207 transmits the information on the setting items that were moved into the operation screen region of the camera 120 to the camera 120. The setting item information includes the displayed names of the setting items and setting values. The setting values may be preset values of the setting items, or may be values specified by the user's voice. Alternatively, the setting values may be set by a physical action performed on the camera 120 after the objects representing setting items have been moved into the operation screen region.

At step S509, the setting information transmission unit 207 does not transmit the information on the setting items to the camera, because the objects representing the setting items that were moved by the user operation are not present within the operation screen region of the camera 120.

At step S510, the CPU 102 of the HMD 101 determines whether or not the user has completed the configuration of setting items. The CPU 102 can determine that the setting item configuration is completed, for example, when the user has pressed a button for instructing completion of setting item configuration. The button for instructing completion of configuration may be equipped to the HMD 101, or to the camera 120. The CPU 102 may determine that the setting item configuration is completed when a user operation such as a gesture or voice instructing completion of setting item configuration is received. The CPU 102 may determine that the setting item configuration is completed when the user takes off the HMD 101. When the setting item configuration is completed, the processing shown in FIG. 5 ends. When the setting item configuration is not completed, the process returns to step S505.

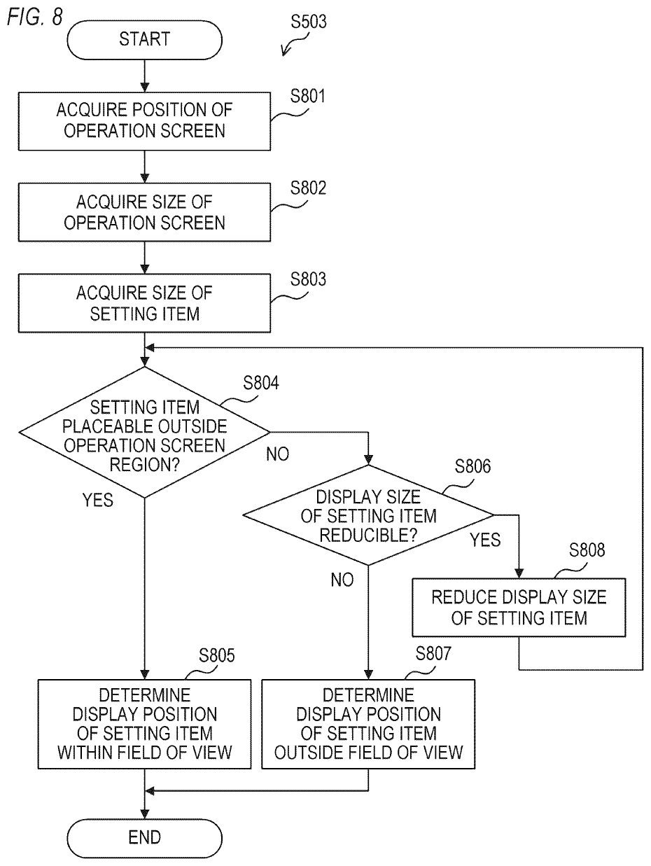

FIG. 8 is a flowchart illustrating an example of processing for determining a display position executed by the display position determination unit 203 at step S503 of FIG. 5. The display position determination unit 203 determines display positions of the objects representing setting items based on the position and size of the operation screen of the camera 120 within the field of view of the HMD 101, and the sizes of the objects representing setting items to be overlaid, for example.

At step S801, the display position determination unit 203 obtains two-dimensional coordinates (x, y) indicating the position of the operation screen of the camera 120 in the field of view of the HMD 101 worn by the user. The display position determination unit 203 obtains the coordinates of either the center of the operation screen, or one of the apexes of four corners, for example, as the position of the operation screen.

At step S802, the display position determination unit 203 obtains the size of the operation screen of the camera 120 in the field of view of the HMD 101 worn by the user. The display position determination unit 203 obtains the vertical and horizontal lengths of the operation screen, for example, as the size of the operation screen.

At step S803, the display position determination unit 203 obtains the sizes (display sizes) of the objects representing setting items to be displayed in the virtual space. The objects representing setting items have respective predetermined sizes, which may be different from each other, or the same.

At step S804, the display position determination unit 203 determines whether or not each of the objects can be placed outside the operation screen region within the field of view based on the position and size of the operation screen, and the sizes of the objects representing setting items obtained at steps S801 to S803. Namely, the display position determination unit 203 determines whether or not the objects representing setting items to be displayed can all be placed in the field of view without overlapping the operation screen region. When the objects representing setting items can all be placed outside the operation screen region in the field of view, the process proceeds to step S805. When some of the objects representing the setting items cannot be placed outside the operation screen region in the field of view, the process proceeds to step S806.

At step S805, the display position determination unit 203 determines display positions of the objects representing setting items in the field of view such as not to overlap the operation screen region. The display position determination unit 203 determines the display positions such that the objects representing setting items do not overlap each other.

Alternatively, the display position determination unit 203 may determine the display positions of the objects representing setting items such as to allow the user to perceive the operation performed on the camera 120 in the real space. The display position determination unit 203 determines the display positions of the objects representing setting items such as not to obstruct visibility of the operation performed on the camera 120. For example, the display position determination unit 203 determines the display positions of the objects representing setting items such as not to overlap the user's hand in the real space.

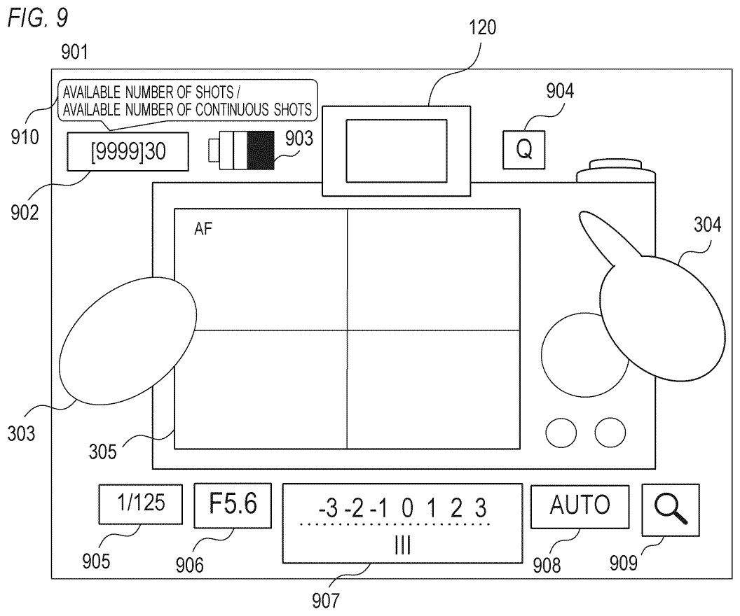

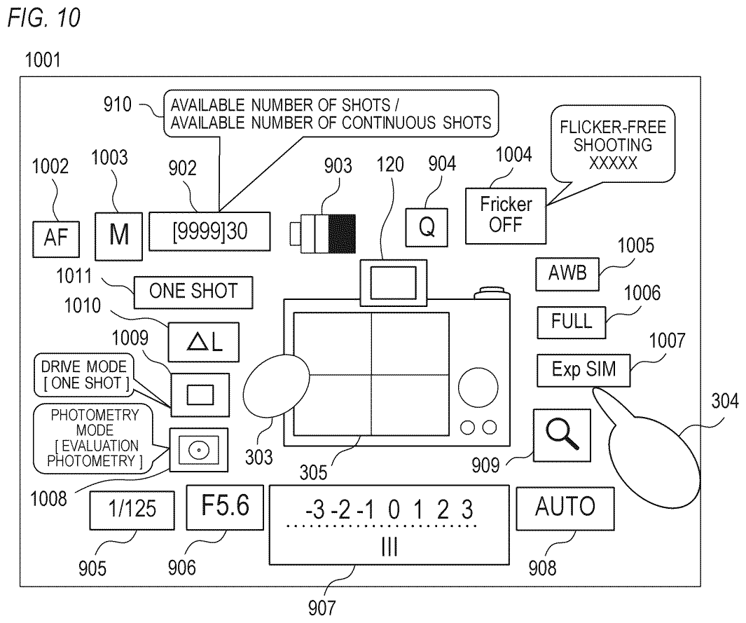

Examples of processing for determination of display positions of objects representing setting items will be described with reference to FIG. 9 and FIG. 10. FIG. 9 and FIG. 10 show examples in which the number and display position of the objects representing setting items placed in the virtual space are changed depending on the size of the operation screen 305 of the camera 120 within the field of view of the HMD 101.

FIG. 9 is a diagram illustrating a display example of objects representing setting items in an image of a virtual space 901 when the user brings the camera 120 closer to the HMD 101. The operation screen 305 of the camera 120 in the image of the virtual space 901 is displayed in a larger size than in the example of FIG. 10 in the field of view of the HMD 101.

In the image of the virtual space 901, the region for displaying objects representing setting items is limited. Therefore, the display position determination unit 203 determines a fewer number of setting items 902 to 909 than in the example of FIG. 10 as setting items to be displayed within the field of view. When the user brings the camera 120 closer to the HMD 101, the display position determination unit 203 can determine which setting items are to be displayed, for example, based on a preset degree of priority.

The display position determination unit 203 may give higher priority to setting items that are used more frequently. Alternatively, the display position determination unit 203 may set the priority so that items related to the setting item that is being manipulated by the user will be displayed with higher priority. Items related to the setting item here may be other setting items in the screen with the same screen ID. Alternatively, relatedness between screen IDs may be predefined, in which case items related to the setting item here may be other setting items in the screen with the same screen ID, as well as corresponding setting items of a screen with a related screen ID.

The display position determination unit 203 determines the display positions such that the objects representing setting items do not overlap each other. The display position determination unit 203 may also determine the display positions such that the setting items with higher priority are placed closer to the region of the operation screen 305.

The user can move the objects representing the setting items 902 to 909 into the region of the operation screen 305 by a hand movement recognized by hand tracking. Reference numeral 910 denotes a text that is a description of the setting item 902. The text is displayed such as to follow the display position of the object representing the setting item 902. The text displayed in the virtual space 901 (description of the setting item) may appear when the object representing the setting item is being displayed outside the region of the operation screen 305, or during the period in which the user is manipulating the setting item.

FIG. 10 is a diagram illustrating a display example of objects representing setting items in an image of a virtual space 1001 when the user moves the camera 120 away from the HMD 101. The operation screen 305 of the camera 120 in the image of the virtual space 1001 is displayed in a smaller size than in the example of FIG. 9 in the field of view of the HMD 101.

In the image of the virtual space 1001, the region for displaying objects representing setting items is larger than in the example of FIG. 9. Therefore, the display position determination unit 203 selects setting items 1002 to 1011 in addition to the setting items 902 to 909 as setting items to be displayed within the field of view.

The objects representing setting items displayed in the image of the virtual space 901 of FIG. 9 and in the image of the virtual space 1001 of FIG. 10 may each have a different size, or may all have the same size. Alternatively, the display position determination unit 203 may determine the size of the object for each setting item based on the priority of each setting item.

The display position determination unit 203 may select objects representing setting items to be displayed in the field of view of the virtual space based on the priority of each setting item. For example, the display position determination unit 203 may determine a setting item as the display target if the degree of its priority is higher than a threshold.

The display position determination unit 203 may determine the display position of the object for each setting item based on the priority of each setting item. For example, the display position determination unit 203 determines the display positions such that an object representing a setting item with higher priority is displayed closer to the operation region of the camera 120.

The display position determination unit 203 may also determine the positions of the objects representing setting items in the depth direction based on priority. Namely, the display position determination unit 203 determines the display positions such that an object representing a setting item with higher priority is displayed more in the foreground (closer to the HMD 101).

The priority of setting items may be a preset degree of priority, or may be set in accordance with the frequency of use of the setting items by the user. The priority of setting items may be set in accordance with relatedness to the setting item being manipulated by the user.

At step S806 in FIG. 8, the display position determination unit 203 determines whether or not the display size of the object representing the setting item obtained at step S803 can be reduced. The display position determination unit 203 can determine whether or not the size can be reduced, for example, based on the visibility of the object, or the legibility of the letters or characters contained in the object. The display position determination unit 203 determines that the size of setting items can be reduced if the display size of the object representing at least one of a plurality of setting items can be reduced. When the display size cannot be reduced, the process proceeds to step S807. When the display size can be reduced, the process proceeds to step S808.

At step S807, the display position determination unit 203 determines display positions of some of the objects representing setting items outside the field of view. In this case, the display position determination unit 203 determines which setting items are to be displayed within the field of view in the order from high to low of the priority of setting items, and determines the display positions of the objects representing the remaining setting items outside the field of view.

At step S808, the display position determination unit 203 reduces the display size of the object representing the setting item, and the process returns to step S804. The display position determination unit 203 may reduce the display size of the objects representing some of a plurality of setting items.

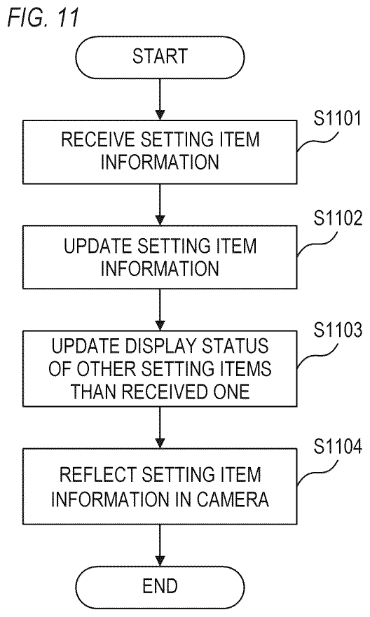

FIG. 11 is a flowchart illustrating an example of a setting process of the camera 120. The processing shown in FIG. 11 is implemented by the CPU 111 executing a program corresponding to each step of the processing. The processing of FIG. 11 is initiated when the HMD 101 transmits setting item information to the camera 120.

At step S1101, the setting information receiving unit 208 of the camera 120 receives the setting item information transmitted from the setting information transmission unit 207 of the HMD 101 via the communication I/F 116. The setting item information includes the name of the displayed item, setting values, and display positions in the operation screen.

At step S1102, the setting information receiving unit 208 updates the setting item information 210 with respect to the received setting item. The setting information receiving unit 208 updates the setting value of the setting item information 210 to the setting value received from the HMD 101, and updates the display status to “Y.”

At step S1103, the setting information receiving unit 208 updates the setting item information 210 with respect to other setting items than the one received from the setting information transmission unit 207. The setting information receiving unit 208 updates the display status of setting item information 210 to “N” with respect to other setting items than the received setting item.

At step S1104, the setting value reflection unit 209 reflects the setting item information 210 in the camera 120. Specifically, the setting value reflection unit 209 displays the object representing the setting item, whose display status is set to “Y” in the setting item information 210, at the position to which the object was moved by the user in the operation screen of the real camera 120. The setting value reflection unit 209 reflects the setting value of the setting item, whose display status is set to “Y” in the setting item information 210, in the camera 120. On the other hand, the setting value reflection unit 209 does not display the setting items, whose display status is set to “N” in the setting item information 210, in the operation screen of the real camera 120.

In Embodiment 1 described above, the HMD 101 changes the objects representing setting items displayed in the virtual space in accordance with the operation screen region of the camera 120 in the virtual space. The objects representing setting items of the camera 120 are displayed outside the operation screen region, so that the user can readily locate a desired setting item. When the user moves an object representing a setting item into the operation screen region, the settings of this setting item are reflected in the camera 120. Accordingly, the user can readily locate desired setting items, and change the settings of the camera 120 with simple operations.

When the user moves an object representing a setting item to a desired position in the operation screen, the camera 120 changes the display position of this setting item in the actual operation screen, too. The user can change the layout of setting items in the operation screen by moving the objects placed outside the operation screen region. The visibility in customizing the operation screen (setting the screen layout) is improved, so that the user can customize the operation screen with simple operations.

In Embodiment 1 described above, the HMD 101 sends setting item information to the camera 120 when an object representing a setting item is moved from outside the operation screen region into the region. This need not necessarily be so. When an object representing a setting item is moved from inside to outside of the operation screen region, the HMD 101 may send the information on the setting item corresponding to the object that was moved out of the operation screen region to the camera 120. In this case, the setting item information includes information indicating that the settings of this setting item have been canceled. The camera 120 stops displaying the setting item that has been moved out of the operation screen region, and cancels the settings of this setting item.

### Embodiment 2

In Embodiment 1, the operation screen of the camera 120 operated by the user is displayed in equal size in the display unit 109 of the HMD 101. In Embodiment 2, the operation screen is displayed in a larger size. The improved visibility of the enlarged operation screen allows the user to more readily check the status of settings of the camera 120.

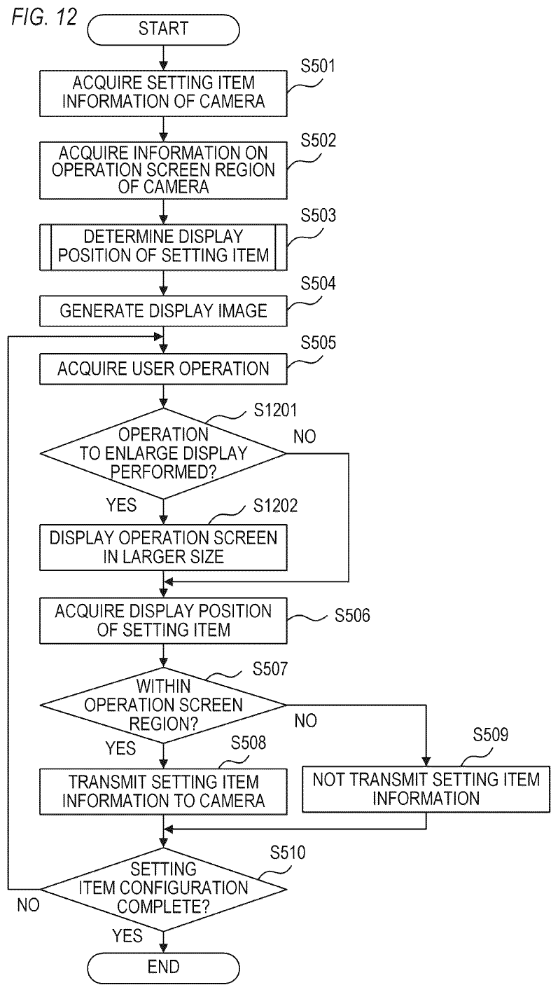

FIG. 12 is a flowchart illustrating an example of processing in the HMD 101 according to Embodiment 2. The same process steps as those of Embodiment 1 shown in FIG. 5 are given the same reference numerals and a detailed account thereof will be omitted.

The processing steps S501 to S505 are the same as the processing steps of FIG. 5. At step S1201, the operation acquisition unit 205 determines whether or not an operation was performed at step S505 for displaying the operation screen in a larger size (hereinafter also referred to as zoom-in action). When there was a zoom-in action, the process proceeds to step S1202. When there was no zoom-in action, the process proceeds to step S506.

The zoom-in action may be an operation performed on a virtual object for displaying the operation screen in a larger size. The zoom-in action may be a voice operation. The zoom-in action may be an operation performed on a button or the like of the camera 120 assigned with the zoom-in function. The zoom-in action may include an operation for specifying a magnification when displaying the operation screen in a larger size.

At step S1202, the image generation unit 204 generates an image showing the operation screen of the camera 120 in a larger size. Specifically, the image generation unit 204 generates a virtual operation screen that is enlarged with a magnification specified by the user, or with a predetermined magnification, and displays it over a real image obtained by the imaging unit 108. The processing steps S506 to S510 are the same as the processing steps of FIG. 5.

In Embodiment 2 described above, the user can reflect the settings in the camera 120, with the operation screen of the camera 120 in the virtual space being displayed in a larger size. Similarly to Embodiment 1, the HMD 101 can display the objects representing setting items in the virtual space in accordance with the operation screen region of the camera 120. When an object representing a setting item is moved into the operation screen region of the camera 120 by a user operation, the settings of this setting item are reflected in the camera 120. This saves the trouble of locating a desired setting item, and allows the user to change the settings of the camera 120 with simple operations.

The embodiments above have all been described for purpose of illustration and not limitation of the present invention; various other variations and modifications are possible in carrying out the present invention.

According to the present invention, users can readily locate desired setting items of an electronic device and change the settings of the electronic device with simple operations.

The various controls described above may or may not be performed by a single hardware (e.g., a processor or circuit). A plurality of hardware (e.g., a plurality of processors, a plurality of circuits, or a combination of one or more processors and one or more circuits) may share the processing to control the entire device.

The above processors are processors in the broadest sense and include both general purpose and specialized processors. The general-purpose processors include, for example, CPU (Central Processing Unit), MPU (Micro Processing Unit), and DSP (Digital Signal Processor). The specialized processors include, for example, GPU (Graphics Processing Unit), ASIC (Application Specific Integrated Circuit), PLD (Programmable Logic Device), etc. The programmable logic devices are, for example, FPGA (Field Programmable Gate Array), CPLD (Complex Programmable Logic Device), etc.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-109839, filed on Jul. 4, 2023, which is hereby incorporated by reference herein in its entirety.

What is claimed is:

1. An information processing device comprising one or more processors and/or circuitry configured to:
perform first acquisition processing to acquire information on a setting item of an electronic device,
perform second acquisition processing to acquire information on an operation screen region of the electronic device in a three-dimensional space that represents a view seen by a user;
perform display control processing to display an object representing the setting item of the electronic device outside the operation screen region in the three-dimensional space, and to change the object being displayed in accordance with the operation screen region in the three-dimensional space; and
perform transmission processing to transmit information on a setting item corresponding to the object that was moved to the electronic device in response to an operation by the user moving the object into the operation screen region.

2. The information processing device according to claim 1, wherein
in the display control processing, a display position of the object is determined based on the operation screen region and the information on the setting item of the electronic device.

3. The information processing device according to claim 1, wherein
in the display control processing, a display position of the object is determined based on a size and a position of the operation screen region.

4. The information processing device according to claim 1, wherein
in the display control processing, a display position of the object is determined such as not to obstruct visibility of an operation performed to the electronic device.

5. The information processing device according to claim 1, wherein
in the display control processing, a display position of the object is determined such that the object does not overlap the operation screen region.

6. The information processing device according to claim 1, wherein
in the display control processing, the object to be displayed is determined based on a degree of priority preset for each setting item of the electronic device, or a degree of priority according to frequency of use of each setting item of the electronic device, or a degree of priority according to relatedness to a setting item being manipulated by the user.

7. The information processing device according to claim 1, wherein
in the display control processing, a display position of the object or a size of the object is determined based on a degree of priority preset for each setting item of the electronic device, or a degree of priority according to frequency of use of each setting item of the electronic device, or a degree of priority according to relatedness to a setting item being manipulated by the user.

8. The information processing device according to claim 1, wherein
in the display control processing, control is performed for displaying the operation screen region in a larger size.

9. The information processing device according to claim 1, wherein
the user operation includes an operation performed with at least one of a hand movement, voice, eye gaze, and gesture.

10. A head-mounted display device comprising:
the information processing device according to claim 1; and
a display configured to display the object.

11. An electronic device comprising one or more processors and/or circuitry configured to:
transmit information on the electronic device to the information processing device according to claim 1;
receive information on a setting item corresponding to the object that was moved into the operation screen region by an operation by the user; and
reflect settings based on the received information on the setting item in the electronic device.

12. The electronic device according to claim 11, wherein
the electronic device is one of a camera, a smartphone, and a printer comprising the operation screen.

13. An information processing method comprising:
acquiring information on a setting item of an electronic device;
acquiring information on an operation screen region of the electronic device in a three-dimensional space that represents a view seen by a user;
displaying an object representing the setting item of the electronic device outside the operation screen region in the three-dimensional space, and changing the object being displayed in accordance with the operation screen region in the three-dimensional space; and
transmitting information on a setting item corresponding to the object that was moved to the electronic device in response to an operation by the user moving the object into the operation screen region.

14. A non-transitory computer-readable medium that stores a program, wherein the program causes a computer to execute the information processing method comprising:
acquiring information on a setting item of an electronic device;
acquiring information on an operation screen region of the electronic device in a three-dimensional space that represents a view seen by a user;
displaying an object representing the setting item of the electronic device outside the operation screen region in the three-dimensional space, and changing the object being displayed in accordance with the operation screen region in the three-dimensional space; and
transmitting information on a setting item corresponding to the object that was moved to the electronic device in response to an operation by the user moving the object into the operation screen region.
